(19) United States
(12) Patent Application Publication
(10) Pub. No.: US 2026/0242154 A1
(43) Pub. Date: Aug. 20, 2026

(54) CONVEYOR SYSTEM

(71) Applicant: A. J. ANTUNES & CO., Carol Stream, IL (US)

(72) Inventors: DAVID ANCHOR, Union, IL (US); ROBERT JONELIS, Crystal Lake, IL (US); JOE CARONE, Darien, IL (US); STEVEN CRAIG BAST, Lombard, IL (US); DAVID LINDBERG, Hampshire, IL (US)

(21) Appl. No.: 19/535,169

(22) Filed: Feb. 10, 2026

Related U.S. Application Data
(60) Provisional application No. 63/760,225, filed on Feb. 19, 2025.

(51) Int. Cl. B65G 43/08; B65G 21/20; B65G 23/44; B65G 39/12

(52) U.S. Cl. CPC B65G 43/08; B65G 21/2072; B65G 23/44; B65G 39/12; B65G 2201/0202; B65G 2203/0233; B65G 2203/044; B65G 2207/26; B65G 2811/09

(57) ABSTRACT

A conveyor system comprising a conveyor extending from a first food product entry end to a second food product discharge end, including at least one drive roller, and a sensor for detecting the presence of a food product upon the conveyor for generating a signal to the drive roller so as to commence the drive of the conveyor, and for terminating the drive of the drive roller after a predetermined time period. In addition, a tensioning system is provided for the conveyor whereby the conveyor belt will be placed under tension or not under tension so that the conveyor belt can be easily installed or removed when the conveyor belt needs to be replaced, repaired, or cleaned.

### FIELD OF THE INVENTION

The present invention relates generally to food service equipment, and more particularly to a conveyor system for conveying food products from one location to another along a food preparation line.

### BACKGROUND OF THE INVENTION

Conveyor systems are obviously well-known and used within the food service industry as a means of conveying food components or food products from one location to another. One drawback with existing conventional conveyor systems is that they are either in constant use or always operating in an ON mode, which severely increases the wear and tear of the system and hence a shorter service life, or the conventional conveyor systems need to be manually switched from their OFF mode to their ON mode, which requires monitored operator personnel. In addition, regardless of usage, eventually the conveyor belts will need to be replaced, however, conventional systems require extensive time and experienced repair personnel to replace the conveyor belts.

A need therefore exists in the art for a new and improved conveyor system. Another need exists in the art for a new and improved conveyor system which is specifically designed for the food service industry. Still another need exists in the art for a new and improved conveyor system which is specifically designed for the food service industry and wherein the new and improved conveyor system is a smart conveyor system in that the conveyor system operates automatically without the need for monitor personnel to operate it between its ON and OFF operational modes. Yet still another need exists in the art for a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor. Still yet another need exists in the art for a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor.

An additional need exists in the art for a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor, whereby the conveyor system will not operate continuously such that wear and tear is significantly reduced and service life is significantly enhanced. A yet additional need exists in the art for a new and improved conveyor system which is specifically designed for the food service industry, wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor, whereby the conveyor system will not operate continuously such that wear and tear is significantly reduced and service life is significantly enhanced, and wherein the smart conveyor is provided with an easy to operate conveyor belt tensioning system which permits the conveyor belt to be readily and easily replaced when necessary.

### OVERALL OBJECTIVES OF THE INVENTION

Therefore, a first overall objective of the present invention is to provide a new and improved conveyor system. Another overall objective of the present invention is to provide a new and improved conveyor system which is specifically designed for the food service industry. Still another need exists in the art for a new and improved conveyor system which is specifically designed for the food service industry and wherein the new and improved conveyor system is a smart conveyor system in that the conveyor system operates automatically without the need for monitor personnel to operate it between its ON and OFF operational modes. Yet still another overall objective of the present invention is to provide a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor.

Still yet overall objective of the present invention is to provide a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor. An additional overall objective of the present invention is to provide a new and improved conveyor system which is specifically designed for the food service industry and wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor, whereby the conveyor system will not operate continuously such that wear and tear is significantly reduced and service life is significantly enhanced.

A yet additional overall objective of the present invention is to provide a new and improved conveyor system which is specifically designed for the food service industry, wherein the new and improved conveyor system is a smart conveyor system in that the conveyor system operates automatically, without the need for monitor personnel to operate it between its ON and OFF operational modes, as a result of sensors detecting the presence of food products deposited onto the conveyor so as to effectively turn the conveyor system ON when the presence of food upon the conveyor is detected and to effectively turn the conveyor system OFF when food products are no longer detected as being present upon the conveyor, whereby the conveyor system will not operate continuously such that wear and tear is significantly reduced and service life is significantly enhanced, and wherein the smart conveyor is provided with an easy to operate conveyor belt tensioning system which permits the conveyor belt to be readily and easily replaced when necessary.

### SUMMARY OF THE INVENTION

The foregoing and other objectives are achieved in accordance with the principles and teachings of the present invention through means of a new and improved conveyor system which comprises a conveyor having an entry end and a discharge end, and a reflective sensor disposed adjacent to the entry end of the conveyor so as to sense or detect the presence of food products deposited onto the conveyor. When the sensor detects the presence of a food item upon the entry end of the conveyor, a signal will be generated by the sensor so as to activate the drive system of the conveyor. The drive system of the conveyor will then be active for a predetermined period of time after the initial detection of the presence of the food item upon the conveyor, whereupon the drive system for the conveyor will then be terminated. This intermittent drive system thus obviates the need to operate the conveyor continuously, thereby reducing wear and tear upon the conveyor and enhancing the overall service life of the conveyor.

Another feature of the present invention comprises a quick-change conveyor belt tensioning system. The conveyor belt is routed around a conveyor drive roller and a conveyor idler/take-up/driven roller, wherein the conveyor idler/take-up/driven roller is operatively mounted upon a movable assembly. The movable assembly comprises a pair of oppositely disposed roller-mounting brackets which are movably mounted upon a pair of oppositely disposed conveyor frame members. The oppositely disposed ends of the idler/take-up/driven roller are mounted upon first ends of the pair of oppositely disposed roller-mounting brackets, while a transversely-oriented mounting plate is mounted upon second ends of the pair of oppositely disposed roller-mounting brackets. In addition, a pair of laterally spaced coiled springs are mounted upon edge portions of the transversely oriented mounting plate which are disposed opposite the edge portion of the transversely oriented mounting plate which is disposed adjacent to the idler/take-up/driven roller, and a pair of laterally spaced cams are mounted upon a rotary shaft which is rotatably mounted upon the pair of oppositely disposed conveyor frame members. A pair of oppositely disposed levers or handles are fixedly connected to oppositely disposed end portions of the rotary shaft such that when the pair of oppositely disposed levers or handles are rotated in a first direction, the pair of laterally spaced cams will cause the pair of oppositely disposed coiled springs to be compressed thereby causing the idler/take-up/driven roller to move to its extended position such that the conveyor belt is tightened or placed under tension so as to render the same taut whereby the conveyor belt can in fact convey the food items from the entry end of the conveyor to the discharge end of the conveyor. Conversely, when the levers or handles are rotated in the opposite direction, the pair of laterally spaced cams will permit the pair of oppositely disposed coiled springs to be decompressed thereby permitting the idler/take-up/driven roller to move to its retracted position such that the conveyor belt is loosened, or the tension relieved, with respect to the idler/take-up/driven roller, and therefore, the conveyor belt may be easily removed for replacement as necessary, for any necessary repairs, or for cleaning operations.

### BRIEF DESCRIPTION OF THE DRAWINGS

Various other objects, features and attendant advantages of the present invention will be more fully appreciated from the following detailed description when considered in connection with the accompanying drawings in which like reference characters designate like or corresponding parts throughout the several views, and wherein:

FIG. 1 is a perspective view of the new and improved conveyor system as developed in accordance with the principles and teachings of the present invention;

FIG. 2 is an enlarged perspective view of the new and improved conveyor system as shown in FIG. 1, showing the details of the reflective sensor and drive motor disposed at the entry end of the conveyor;

FIG. 3 is a top plan view of the drive roller assembly;

FIG. 4 is a top plan view of the idler/take-up/driven roller assembly and the tensioning system utilized in conjunction with the same, wherein the tensioning springs are compressed such that idler/take-up/driven roller is moved to its extended position so as to place the conveyor belt under tension;

FIG. 5 is a cross-sectional view showing the operative components of the idler/take-up/driven roller tensioning system as illustrated within FIG. 3;

FIG. 6 is a top plan view of the idler/take-up/driven roller assembly and the tensioning system utilized in conjunction with the same, wherein the tensioning springs are uncompressed such that idler/take-up/driven roller is moved to its retracted position so as to relieve the conveyor belt from any tension whereby the conveyor belt may be easily removed from the conveyor for service, repair, or replacement;

FIG. 7 is a bottom plan view of the new and improved conveyor wherein sensors are utilized to ensure that the side panels of the conveyor are in fact properly mounted upon the frame assembly of the computer;

FIG. 8 is a first alternative embodiment of a conveyor system wherein multiple conveyors are utilized to convey food products to different destinations; and

FIG. 9 is a second alternative embodiment of a conveyor system wherein multiple conveyors are utilized to convey food products to different destinations.

### DETAILED DESCRIPTION OF THE PREFERRED EMBODIMENT

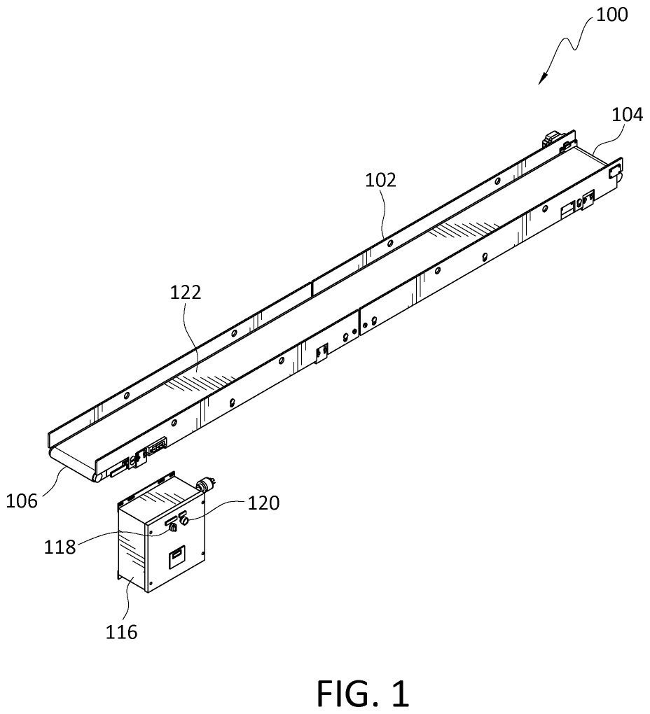

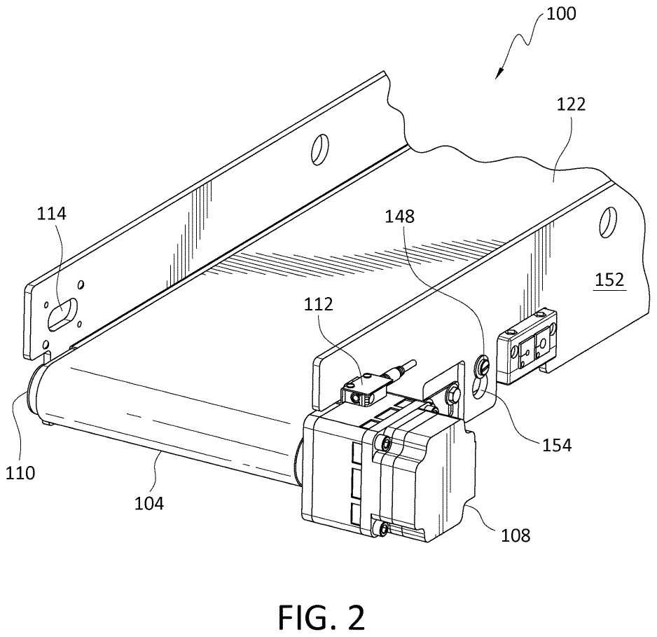

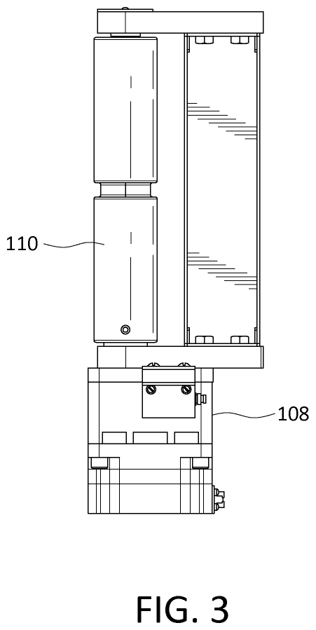

Referring now to the drawings, and more particularly to FIGS. 1-3 thereof, the new and improved conveyor system is disclosed and is generally indicated by the reference number 100. More particularly, the new and improved conveyor system 100 is seen to comprise a conveyor 102 that extends from a first entry end 104 to a second opposite discharge end 106. As is best seen in FIG. 2, a suitable drive motor 108 is operatively connected to a drive roller 110 of the conveyor 102, and a reflective sensor 112, which comprises both a transmitter and a receiver, is disposed adjacent to the entry end 104 of the conveyor 102 while a reflector 114 is likewise disposed adjacent to the entry end 104 of the conveyor 102 so as to be disposed directly opposite the reflective sensor 112. The reflective sensor 112 will constantly emit a beam of light, either a laser beam or an infrared beam, which will be reflected back toward the reflective sensor 112 by means of the reflector 114. However, if a food product is deposited onto the entry end 104 of the conveyor 102, then the food product will effectively interrupt the light beam emitted by means of the reflective sensor 112, the light beam will therefore not be reflected back toward the reflective sensor 112 by means of the reflector 114, and therefore, the reflective sensor 112, sensing this absence of the returned or reflected light beam, will generate a signal so as to activate the conveyor drive motor 108.

Once the reflective sensor 112 generates the signal to start the conveyor 102, the conveyor drive motor 108 will begin to operate and will be active for a predetermined period of time after the reflective sensor 112 no longer senses the presence of the food product, whereupon, after the predetermined period of time times out, a signal will be generated to terminate the actuation of the conveyor drive motor 108. This predetermined period of time will be based upon the operative speed of the conveyor 102, which is known, whereby sufficient time is allotted to permit the food product to reach the discharge end 106 of the conveyor 102. It is therefore to be noted that this intermittent drive system for the conveyor 102 obviates the need to operate the conveyor 102 continuously, thereby reducing wear and tear upon the conveyor 102, and enhancing the overall service life of the conveyor 102. Lastly, it is noted that an electrical control box 116 is operatively connected to the conveyor 102, and is seen to comprise a three-position mode selection button 118 whereby the operation of the conveyor 102 may be OFF, MANUAL, that is, the conveyor 102 may be operated by personnel through means of a suitable interface, not shown, or AUTOMATIC, that is the conveyor 102 is operated in accordance with the foregoing food product detection mode of operation. Still further, the electrical control box 116 includes a RESET button 120 such that if the operation of the conveyor 102 is shut down, terminated, or interrupted for any reason, such as, for example, a malfunction, a conveyor jam, or the like, the RESET button 120 can be depressed to again start the conveyor 102 after the conveyor interruption has been resolved.

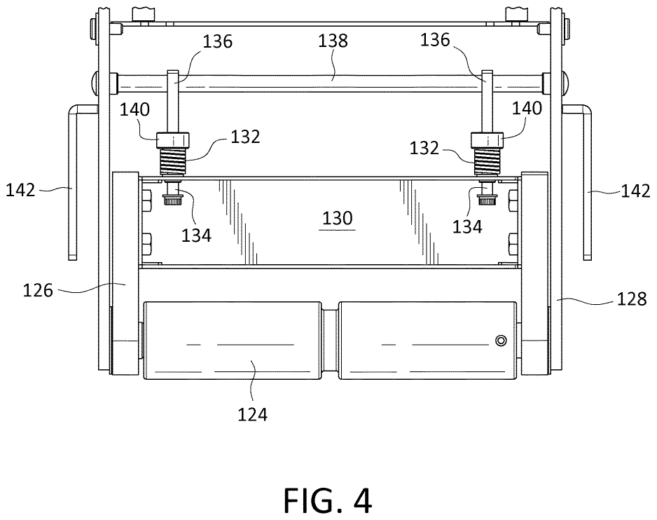

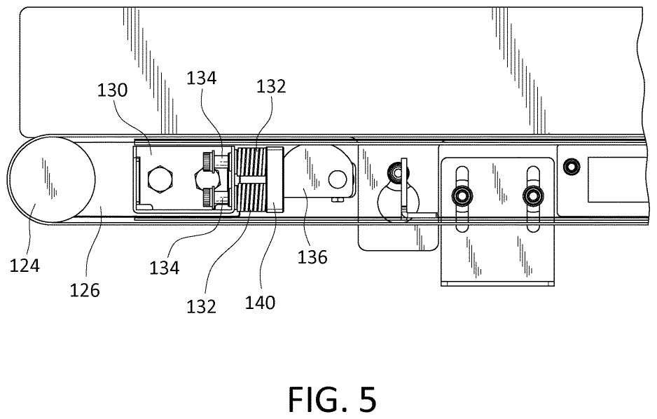

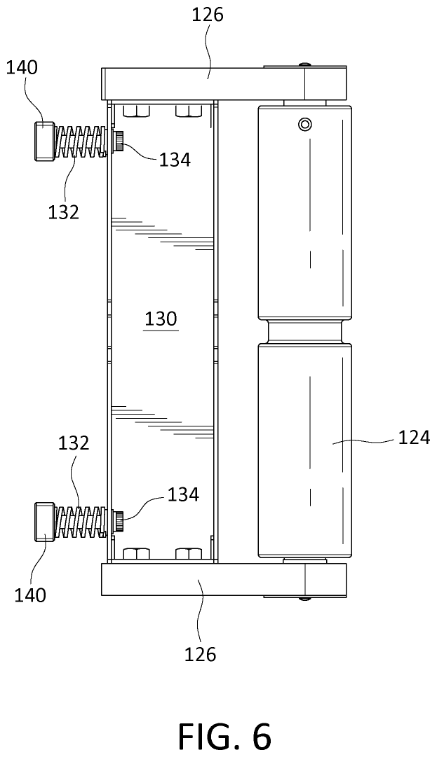

With reference now being made to FIGS. 4-6, another feature of the present invention comprises a quick-change conveyor belt tensioning system. The conveyor 102 comprises a conveyor belt 122 which is routed around the conveyor drive roller 110 and an oppositely disposed conveyor idler/take-up/driven roller 124, and it is seen that the conveyor idler/take-up/driven roller 124 is operatively mounted upon a slidable assembly. More particularly, the slidable assembly comprises a pair of oppositely disposed roller-mounting brackets 126,126 which are movably mounted upon a pair of oppositely disposed conveyor frame members 128,128. The oppositely disposed ends of the idler/take-up/driven roller 124 are mounted upon first ends of the pair of oppositely disposed roller-mounting brackets 126, while a transversely-oriented mounting plate 130 is mounted upon second opposite ends of the pair of oppositely disposed roller-mounting brackets 126,126. In addition, it is seen that a pair of laterally spaced coiled springs 132,132 are disposed around a pair of laterally spaced studs 134,134 which are mounted upon inner edge portions of the transversely oriented mounting plate 130 that are disposed opposite the edge portion of the transversely oriented mounting plate 130 which is disposed adjacent to the idler/take-up/driven roller 124, and a pair of laterally spaced cams 136,136 are fixedly mounted upon a rotary shaft 138 which has its ends rotatably mounted within the pair of oppositely disposed conveyor frame members 128, 128.

Still further, a pair of laterally spaced cam followers 140,140 are interposed between the pair of laterally spaced coiled springs 132,132 and the pair of laterally spaced cams 136,136, and a pair of oppositely disposed levers or handles 142,142 are fixedly connected to oppositely disposed end portions of the rotary shaft 138. In this manner, when the pair of oppositely disposed levers or handles 142,142 are rotated in a first direction, the pair of laterally spaced cams 136, 136 will cause the pair of oppositely disposed coiled springs 132,132 to be compressed thereby causing the idler/take-up/driven roller 124 to move to its extended or outermost position such that the conveyor belt 122 is tightened or placed under tension so as to render the same taut whereby the conveyor belt 122 can in fact convey the food items from the entry end 104 of the conveyor 100 to the discharge end 106 of the conveyor 100. Conversely, when the levers or handles 142,142 are rotated in the opposite direction, the pair of laterally spaced cams 136,136 will permit the pair of oppositely disposed coiled springs 132,132 to be decompressed thereby permitting the idler/take-up/driven roller 124 to move to its retracted or innermost position such that the tension within the conveyor belt 122 is relieved whereby the conveyor belt 122 is effectively loosened with respect to the idler/take-up/driven roller 124, whereby the conveyor belt 122 may then be easily removed or installed during replacement, if necessary, or may be removed for any necessary repairs, or may be removed for cleaning operations. It is also to be noted that the provision of the pair of oppositely disposed coiled springs 132,132 also permits proper tension to be impressed and maintained upon the conveyor belt 122 when the same will tend to somewhat stretch or lengthen over time due to extensive use during its service life.

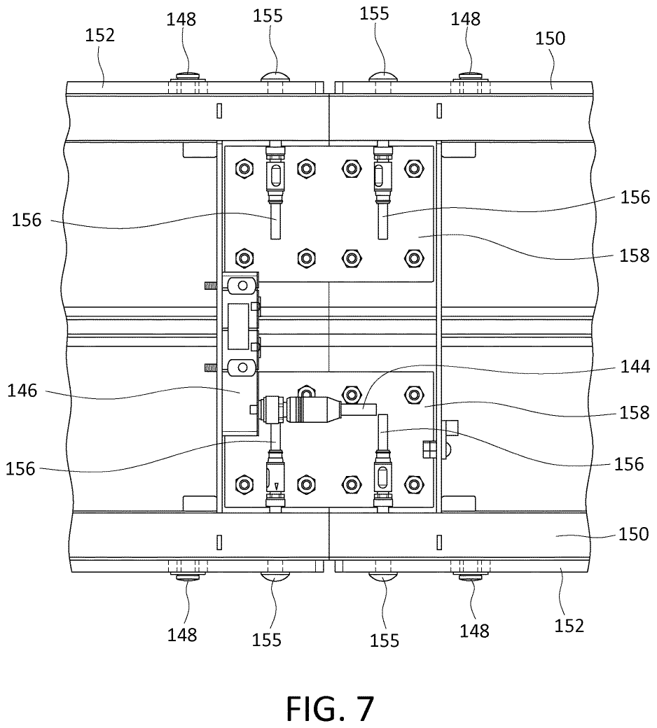

Referring now to FIG. 7, the electrical power junction for the conveyor 102 is disclosed. More particularly, it is seen that an electrical power infeed cable 144 is connected to an electrical power distribution block 146 so as to transmit electrical power to the various electrical components of the conveyor system 100, such as, for example, the drive motor 108, the reflective sensor 112, and the like. In addition, four headed bolts 148,148, 148,148, arranged in two oppositely disposed pairs, are fixedly mounted within the oppositely disposed side portions 150, 150 of the conveyor frame such that headed portions of the headed bolts 148,148, 148, 148 protrude a predetermined distance away from the side portions 150,150 of the conveyor frame. A pair of oppositely disposed conveyor guide panels 152,152 are adapted to be mounted upon the oppositely disposed lateral side portions 150,150 of the conveyor frame, and in order to accomplish this, it is seen that the pair of oppositely disposed conveyor guide panels 152,152 are provided with keyhole slots 154, as can best be seen or appreciated from FIG. 2. In this manner, the keyhole slots 154 of the conveyor guide panels 152, 152 can be passed over the head portions of the headed bolts 148, 148, 148, 148 whereby the conveyor guide panels 152,152 can then be moved downwardly relative to the headed bolts 148,148, 148,148 such that the pair of oppositely disposed conveyor guide panels 152,152 are properly mounted upon the side portions 150, 150 of the conveyor frame.

In order to ensure that the pair of oppositely disposed conveyor guide panels 152,152 are in fact properly mounted upon the side portions 150,150 of the conveyor frame, four round head positioning bolts 155, 155, 155,155, arranged in two oppositely disposed pairs, are fixedly mounted within the pair of oppositely disposed conveyor guide panels 152,152. In addition, four proximity sensors 156, 156,156, 156, arranged in two oppositely disposed pairs, are provided upon the conveyor 102 such that when the pair of oppositely disposed conveyor side panels 152, 152 are properly mounted and seated upon the side portions 150,150 of the conveyor frame, after the keyhole slots 154 of the conveyor guide panels 152, 152 have been passed over the head portions of the headed bolts 148,148, 148, 148 and the conveyor guide panels 152,152 have been lowered downwardly relative to the plurality of headed bolts 148, 148, 148, 148, the plurality of round head positioning bolts 155,155, 155,155 will be aligned with the plurality of proximity sensors 148,148, 148, 148 whereby the plurality of proximity sensors 148, 148, 148, 148 will provide signals indicating that the pair of oppositely disposed conveyor side panels 152,152 have in fact been fully, completely, and properly mounted upon the opposite disposed side frame portions 150, 150 of the conveyor 102. It is lastly noted that a pair of oppositely disposed connector plates 158, 158 are provided upon the conveyor 102 for fixedly connecting serially located sections of the conveyor 102 together.

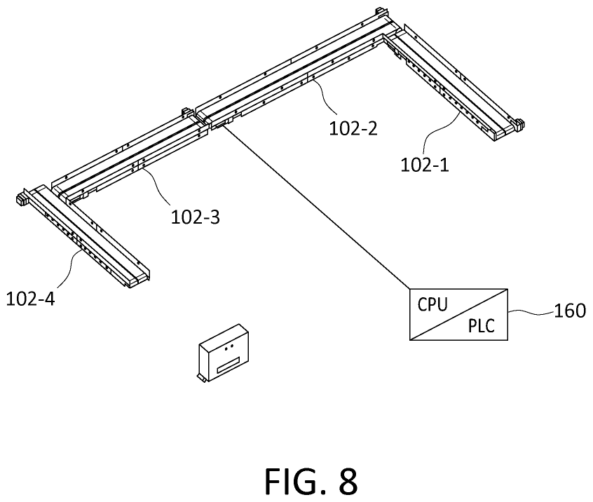

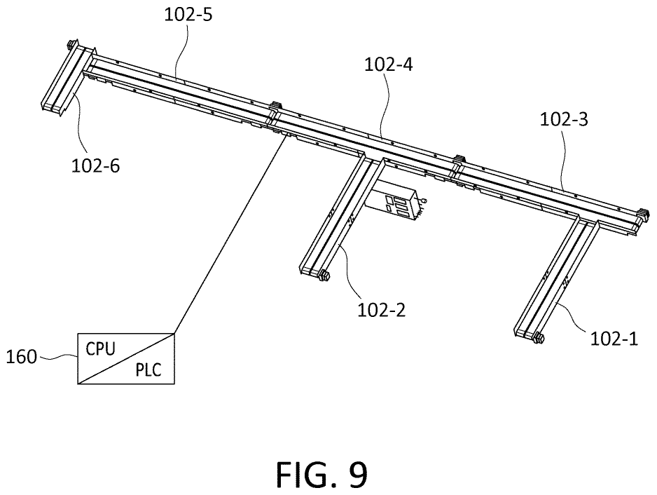

With reference lastly being made to FIGS. 8 and 9, the conveyor 102 may be incorporated within an expanded or enlarged conveyor system which may comprise a plurality of serially arranged conveyors 102 which are all operatively connected together under the control of a suitable computer 160 which may be a central processing unit (CPU) or programmable logic computer (PLC). More particularly, as shown in FIG. 8, a first conveyor 102-1 may be the infeed conveyor upon which a food product is initially placed, and after its reflective sensor 112 detects the presence of the food product upon the conveyor 102-1, the conveyor belt 122 of this first conveyor 102-1 will be activated by means of its drive motor 108. Since the speed of the conveyor 102-1 is known, then the computer 160 will activate the second conveyor 102-2 at a predetermined time subsequent to the activation of the first conveyor 102-1 such that the second conveyor 102-2 can convey the food product from the first conveyor 102-1 to a third conveyor 102-3 which will likewise be activated by means of the computer 160 at a predetermined after the second conveyor 102-2 has been activated. The third conveyor 102-3 will then convey the food product to a fourth conveyor 102-4, which is the food product discharge conveyor and which will likewise be activated by the computer 156 at a predetermined time subsequent to the activation of the third conveyor 102-3.

In a similar manner, and with reference being made to FIG. 9, this enlarged or expanded conveyor system is seen to comprise six conveyors 102. More particularly, the first and second conveyors 102-1 and 102-2 are food product infeed conveyors upon which food products are initially placed. Accordingly, if a food product is placed onto the first conveyor 102-1, then after its reflective sensor 112 detects the presence of the food product upon the conveyor 102-1, the conveyor belt 122 of this first conveyor 102-1 will be activated by means of its drive motor 108. Since the speed of the conveyor 102-1 is known, then the computer 160 will activate the third conveyor 102-3 at a predetermined time subsequent to the activation of the first conveyor 102-1 such that the third conveyor 102-3 can convey the food product from the first conveyor 102-1 to a fourth conveyor 102-4 which will likewise be activated by means of the computer 160 at a predetermined after the third conveyor 102-3 has been activated. The fourth conveyor 102-4 will then convey the food product to a fifth conveyor 102-5, wherein the computer 160 will activate the fifth conveyor 102-5 at a predetermined time subsequent to the activation of the fourth conveyor 102-4 such that the fifth conveyor 102-5 can convey the food product from the fourth conveyor 102-4 to a sixth conveyor 102-6 which will likewise be activated by means of the computer 160 at a predetermined after the fifth conveyor 102-5 has been activated. The sixth conveyor 102-6 is the food product discharge conveyor which will then deliver the food product to the next food preparation station.

Alternatively, if a food product is placed onto the second conveyor 102-2, then after its reflective sensor 112 detects the presence of the food product upon the conveyor 102-2, the conveyor belt 122 of this second conveyor 102-2 will be activated by means of its drive motor 108, while the first conveyor 102-1 is not activated at all since no food product was detected as having been present upon the first conveyor 102-1. Since the speed of the conveyor 102-2 is known, then the computer 160 will activate the fourth conveyor 102-4 at a predetermined time subsequent to the activation of the second conveyor 102-2 such that the fourth conveyor 102-4 can convey the food product from the second conveyor 102-2 to a fifth conveyor 102-5 which will likewise be activated by means of the computer 160 at a predetermined after the fourth conveyor 102-4 has been activated. The fifth conveyor 102-5 will then convey the food product to the sixth conveyor 102-6, wherein the computer 160 will activate the sixth conveyor 102-6 at a predetermined time subsequent to the activation of the fifth conveyor 102-5 such that the sixth conveyor 102-6 can convey the food product from the fifth conveyor 102-5 to its discharge end since the sixth conveyor 102-6 is the food product discharge conveyor which will then deliver the food product to the next food preparation station.

Obviously, many variations and modifications of the present invention are possible in light of the above teachings. For example, depending upon particular modes of operation that may be desired or required, the multiple conveyors disclosed within FIGS. 8 and 9 may be operated in groups, as opposed to individually, under the control of the central processing unit (CPU) or programmable logic computer (PLC). It is therefore to be understood that within the scope of the appended claims, the present invention may be practiced otherwise than as specifically described herein.

What is claimed as new and desired to be protected by letters patent, is:

1. A conveyor system for conveying food items from a point of entry to a point of discharge, comprising:
at least one conveyor extending from a first food product entry end to a second food product discharge end;
at least one drive roller;
a motor drive for driving said at least one drive roller; and
at least one sensor operatively associated with said first food product entry end of said at least one conveyor for detecting the presence of a food product upon said first food product entry end of said at least one conveyor, and for generating a signal to said motor drive in response to detecting the presence of the food product upon said first food item entry end of said at least one conveyor so as to activate said motor drive and thereby commence the drive of said at least one conveyor whereby said at least one conveyor can convey the food product from said first food product entry end of said at least one conveyor to said second food product discharge end of said at least one conveyor, wherein said motor drive is deactivated after a predetermined period of time if no further food items are detected upon said first food product entry end of said at least one conveyor,
whereby such intermittent, non-continuous operation of said at least one conveyor will reduce wear and tear of said at least one conveyor and improve the service life of said at least one conveyor.

2. The conveyor system as set forth in claim 1, wherein:
said at least one sensor comprises a reflective sensor.

3. The conveyor system as set forth in claim 2, wherein said reflective sensor comprises:
a transmitter/receiver for emitting a beam of light; and
a reflector for receiving said beam of light and reflecting said beam of light back toward said transmitter/receiver,
whereupon a food product interrupting said beam of light, said reflective sensor will generate said signal to said motor drive so as to activate said motor drive in order to commence the drive of said at least one conveyor.

4. The conveyor system as set forth in claim 1, wherein:
said at least one sensor comprises a laser sensor.

5. The conveyor system as set forth in claim 1, wherein:
said at least one sensor comprises an infrared sensor.

6. The conveyor system as set forth in claim 1, further comprising:
said at least one conveyor, extending from said first food product entry end to said second food product discharge end, comprises a conveyor belt;
an idler/take-up/driven roller operatively associated with said second food product discharge end of said at least one conveyor; and
a tensioning system for moving said idler/take-up/driven roller with respect to said at least one conveyor between a first position at which said conveyor belt will be placed under tension so that said conveyor belt is taut and can convey food products from said first food product entry end to said second food product discharge end, and a second position at which said conveyor belt is not under tension and is loosened/slack whereby said conveyor belt can be removed/installed from/onto said idler/take-up/driven roller such that said conveyor belt can be replaced, repaired, or cleaned.

7. The conveyor system as set forth in claim 6, wherein said tensioning system comprises:
said idler/take-up/driven roller is mounted upon movable mounting brackets; and
at least one rotary cam operatively engaged with said idler/take-up/driven roller such that when said at least one cam is disposed in a first rotary position, said idler/take-up/driven roller will be moved to an extended position so as to render said conveyor belt taut, whereas when said at least one cam is disposed in a second rotary position, said idler/take-up/driven roller will be moved to an retracted position so as to permit said conveyor belt to be loosened/slack such that said conveyor belt may be easily installed/removed upon/from said idler/take-up/driven roller.

8. The conveyor system as set forth in claim 7, wherein:
at least one cam follower adapted to be engaged with said at least one rotary cam; and
at least one coiled spring interposed between said at least one cam follower and said mounting brackets for imparting/relieving tension to/from said mounting brackets so as to move said idler/take-up/driven roller between said extended position and said retracted position.

9. The conveyor system as set forth in claim 7, further comprising:
at least one conveyor frame member;
a rotary shaft mounted upon said at least one conveyor frame member and having said at least one rotary cam fixedly mounted upon said rotary shaft; and
at least one handle fixedly connected to said rotary shaft such that said rotary shaft, and said at least one rotary cam, can be moved between said first and second rotary positions.

10. The conveyor system as set forth in claim 1, wherein:
said at least one conveyor comprises a conveyor frame having opposite lateral side portions; and
a pair of guide panels are adapted to be mounted upon said opposite lateral side portions of said conveyor frame.

11. The conveyor system as set forth in claim 10, wherein:
each one of said opposite lateral side portions of said conveyor frame includes at least one headed bolt; and
each one of said pair of guide panels includes a keyhole slot for permitting each one of said pair of guide panels to be respectively mounted upon each one of said opposite lateral side portions of said conveyor frame as a result of said at least one headed bolt moving through said keyhole slot.

12. The conveyor system as set forth in claim 10, wherein:
each one of said pair of guide panels includes a positioning bolt; and
a proximity sensor is disposed upon said conveyor frame for detecting the presence of each positioning bolt so as to ensure that said pair of guide panels are properly installed upon said conveyor frame.

13. The conveyor system as set forth in claim 1, wherein:
said at least one conveyor comprises a plurality of conveyors arranged in a serial manner.

14. The conveyor system as set forth in claim 13, further comprising:
a computer for controlling the conveying operations of all of said plurality of conveyors arranged in said serial manner.

15. The conveyor system as set forth in claim 14, wherein:
said computer is selected from the group comprising a central processing unit (CPU) and a programmable logic computer (PLC).
